(19) United States
(12) Patent Application Publication
(10) Pub. No.: US 2025/0265716 A1
(43) Pub. Date: Aug. 21, 2025

(54) MEDICAL IMAGE CONTRAST SUPER-IMPOSITION

(71) Applicant: Siemens Healthineers AG, Forchheim (DE)

(72) Inventors: Feng Qiu, Pennington, NJ (US); Lining Yang, East Windsor, NJ (US)

(21) Appl. No.: 18/582,990

(22) Filed: Feb. 21, 2024

(51) Int. Cl. G06T 7/00; G06T 5/94

(52) U.S. Cl. CPC G06T 7/0014; G06T 5/94; G06T 2207/10081; G06T 2207/10088; G06T 2207/30092; G06T 2210/41

(57) ABSTRACT

A system for generating contrast reformation data includes image processing circuitry configured to generate two-dimensional reformation data for three-dimensional image data by straightening a centerline of the lumen of an imaged patient and unfolding the three-dimensional medical image data about the straightened centerline. Points in the three-dimensional image data are registered to points in two-dimensional contrast image data. The unfolding is used to translate the registration for the three-dimensional image data to the two-dimensional reformation data. Contrast information from the two-dimensional contrast image data is super-imposed onto the two-dimensional reformation data to generate the contrast reformation data.

### TECHNICAL FIELD

This disclosure relates to super-imposing contrast data into medical images.

### BACKGROUND

Medical imaging involves multiple steps with regard to the presentation of images to a medical viewer for review. Data is captured by an imaging capture system. In the case of many three-dimensional (3D) imaging systems, such as magnetic resonance imaging (MRI) systems and computed tomography (CT) scan, the data is captured in a capture space, such as k-space. Then the data is reconstructed into a spatial image. In some cases, processing is used to further remove artifacts or improve the resolution of the reconstructed image. The spatial image may then be presented to the medical viewer. Systems that improve the viewability of medical images via the enhancement of capture, reconstruction, and/or post-processing of medical images will continue to drive demand and adoption of medical imaging technologies.

### BRIEF DESCRIPTION OF THE DRAWINGS

FIG. 1 shows an example image processing system.

FIG. 2 shows example image processing logic.

FIG. 3 shows an example image processing computation environment.

FIG. 4 shows an illustrative example image processing system.

### DETAILED DESCRIPTION

In various contexts, three-dimensional (3D) medical images may present a challenge for medical viewers to view and analyze. As an illustrative scenario, such images may be viewed on a two-dimensional (2D) display and/or from a particular perspective in a 3D view space. Accordingly, viewing a particular 2D portion or perspective of the 3D medical image may result in portions of the 3D medical image being non-visible. Accordingly, in at least some cases, the medical viewer may use an extended viewing session to view the 3D image in multiple 2D sections, multiple perspectives, or both.

Further, some extended organs, tissues, or other patient features may occupy a complex path or space within a 3D volume. For example, lumens (e.g., blood vessels, digestive tract portions, lymphatics, or other tubular tissues/organs) may wind along a complex path that may not necessarily stay within any single plane within a 3D space. It should be noted that, although the capture of contrast images may use different techniques, other extended organs, such as nerves and/or ganglia, are functionally equivalent to and interchangeable with lumens for the purposes of the super-imposition of contrast data techniques and architectures discussed herein, e.g., once capture of 2D contrast image data and 3D medical image data has been performed for the extend organ.

In some cases, 3D image post processing may be used to increase the portion of the 3D image data that can be viewed from a single frame on a 2D display (e.g., from a single 2D plane or from a single perspective). Curved planar reformation (CPR), which may be used to obtain 2D reformation data from 3D medical image data, determines a centerline for the lumen and straightens the centerline. For example, the pixels making up the centerline of the lumen in the volume of the 3D medical image data are presented as a straight line in the 2D reformation data. The image data is then arranged along the straightened centerline.

The CPR process then unfolds the segmented image data portions as arranged about the straightened centerline into a single plane with the straightened centerline. In some cases, the straightened centerline may progress through a centerline of the plane of the 2D reformation data. Thus, the center of the viewable 2D reformation data is the center of the lumen.

As a result, the complex path of and at least a portion of the volume surrounding the lumen may be viewed in a single 2D frame of a display (or printed image).

Nevertheless, the 2D reformation data image may be complex to comprehend for a medical viewer because 3D image data is unfolded into a 2D plane. The unfolding of a volume into a 2D plane results in a high information density. In other words, the 2D reformation data image is a “busy” image with a lot of information for a viewer to understand and process. Thus, according to the conventional wisdom, it is important to avoid adding additional information to such “busy” medical images to avoid information overload for the medical viewer. Thus, following the conventional wisdom, a CPR image is balanced between a trade-off between information density in the 2D reformation data image and the desire to have a wholistic view of a lumen within a single 2D plane.

Contrary to the conventional wisdom and as recognized herein, contrast image data, such as that from a fluoroscopic image or other contrast image, may be super-imposed onto 2D reformation data image, thereby increasing the overall information in the combined image, but provide the medical viewer with additional information the enhances the ability of the medical comprehend the 2D reformation data image. Unexpectedly, the addition of the super-imposed contrast image information reduces the perceived busyness of the 2D reformation data image rather than increasing the perceived busyness, because the addition of the contrast image information allows the medical viewer to focus on features of interest more quickly. In other words, the additional contrast image information acts as a guide for the 2D reformation data image, without obscuring portions of the 2D reformation data image or increasing visual clutter within the 2D reformation data image.

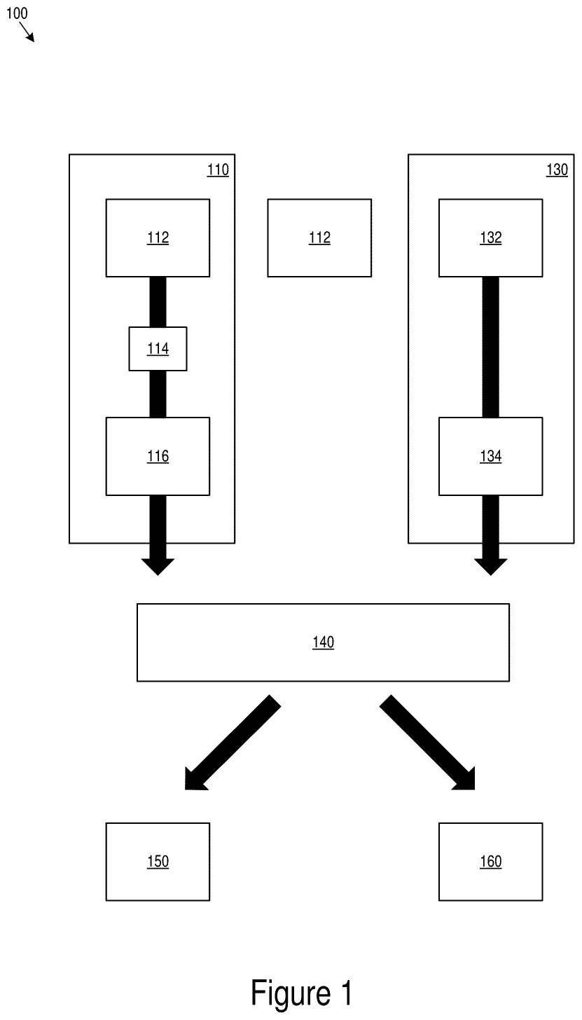

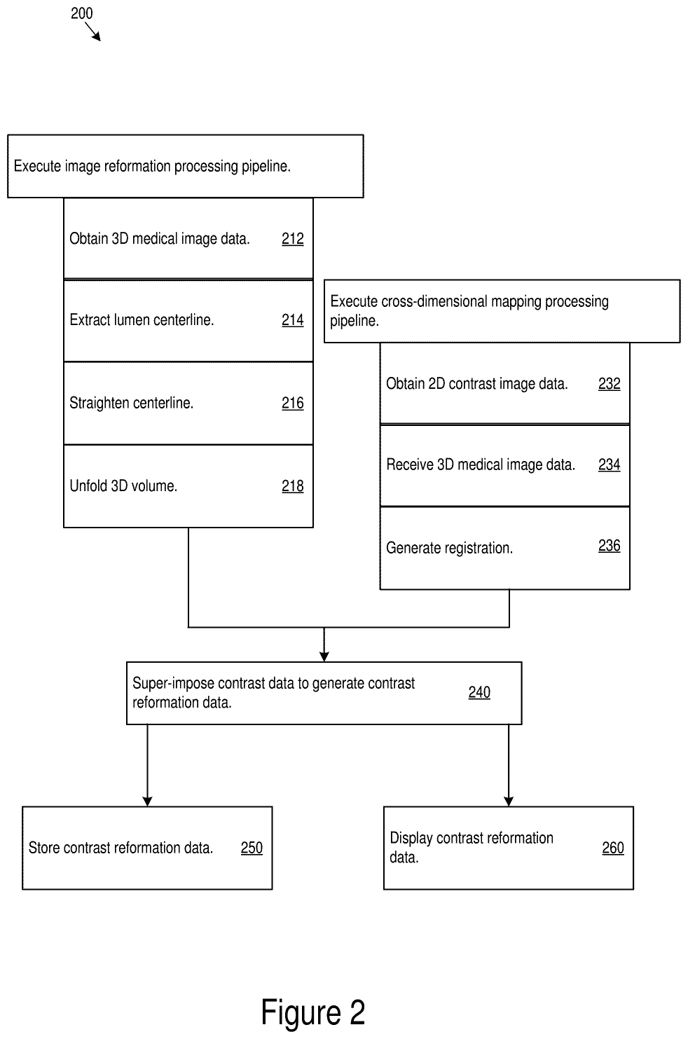

FIG. 1 shows an example image processing system 100. Reference is also made to FIG. 2, which shows example image processing logic 200, which may govern the operation of the example image processing system 100. The image processing logic 200 may execute on circuitry, e.g., image processing circuitry.

The image processing logic 200 may execute image processing on 3D medical image data and registration operations on 2D contrast data. The operations may be performed in succession, in interlaced operations, and/or in parallel (e.g., on pipelines operating in parallel). For the purposes of illustration, the operations are discussed as being executed on parallel processing pipelines. However, various implementations may implement some or all of the operations using serial processing and/or interlaced operations, where operations from each pipeline are interspersed with one another.

The image processing logic 200 may obtain, at an image reformation processing pipeline 110, 3D medical image data 112 (212). The 3D medical image data 112 may include image data for a patient from magnetic resonance imaging (MRI) systems and/or computed tomography (CT) systems. The 3D medical image data 112 may be obtained in a reconstructed form, such that the image data is an image in a 3D volume, rather than raw k-space and/or frequency space data from an MRI and/or CT system. Nevertheless, in some cases, the image reformation processing pipeline 110 may perform image reconstruction on raw captured data directly from a 3D medical imaging system.

In some implementations, the 3D medical image data 112 may be synthesized and/or generated, e.g., via AI denoising or other process. For example, 2D medical images may be transformed via AI generative processing into 3D medical image data. Various other 3D medical image data may be used.

The image processing logic 200 may obtain, at a cross-dimensional mapping processing pipeline 130, 2D contrast image data 132 (232). The 2D contrast image data 132 may include medical image data, where a portion of the capture process selectively enhances the relative visibility of a particular portion of the anatomy of the patient being imaged. For example, a contrast image may include a fluoroscopic image, where the patient is exposed to a contrast dye to enhance visibility of the tissues subject to the dye (and/or the tissues to which the dye bonds, adheres, collects within, or otherwise remains proximate to) while the patient is imaged.

In some cases, a contrast image may be generated via synthesis of the contrast enhancement. For example, a trained AI system may apply a synthetic contrast colorization based on tissue boundary tracing, density data attached to pixel locations, and/or other base information.

The image processing logic 200 may share the 3D medical image data 112 with the cross-dimensional mapping processing pipeline 130 (234), such that the cross-dimensional mapping processing pipeline 130 may execute mapping and mapping translations based on the 3D medical image data 112.

Referring again to operations at the image reformation processing pipeline 110, the image processing logic 200 may extract a centerline 114 of a lumen of the patient imaged within the 3D medical image data 112 (214).

In some cases, the lumen may include a segment of a network of lumens imaged within the 3D medical image data 112. The segment may include a segment selected within a process of “by-parts” image processing of the network of lumens as a whole. Thus, other portions of the network of lumens may be processed along with the segment in a serial and/or parallel fashion. In some cases, the segment may be selected as a segment of interest based on an anomalous feature identified on the segment. For example, a lesion or other abnormality may be identified via AI-based or viewer-based analysis of the 3D medical image data 112 and/or 2D contrast image data. Thus, the lumen segment is flagged for additional image processing. In some cases, a viewer may select a segment for additional image processing whether or not an anomalous feature is identified. In some cases, the segment may be selected due to the availability of contrast image data. For example, contrast images may be available for some portions of the lumen network but not others. Other selection criteria for segments may be implemented.

In some implementations, the extraction of the centerline may include a performing volume skeletonization of the 3D medical image data 112 to trace the position of the lumen (and/or a network containing the lumen) within the 3D medical image data 112. In some cases, various volume skeletonization schemes may be used such as boundary peeling, distance coding, and/or voxel coding.

The image processing logic 200 may straighten the extracted centerline 114 (216). The straightening of the centerline may result in the centerline being straight so that it may be fully represented on a single image plane. In various implementations, the straightened centerline may form a centerline of an image plane for the 2D reformation image data 116 generated by the image reformation processing pipeline 110.

After the straightening of the centerline, the image processing logic 200 may unfold the volume of the 3D medical image data 112 around the centerline and onto the plane of the 2D reformation image data 116 (218). The unfolding may include a transformation of the 3D volume of the medical image data into a curved 2D planar form. Thus, rectilinear-volume-to-curved-plane transformation techniques may be used. The various transformations may, in some cases, use non-linear transformation techniques. Thus, in some cases, each voxel of the 3D volume of the medical image data may have representation in a pixel in the plane of the 2D reformation image data 116. Nevertheless, a single voxel may have representation in multiple pixels of the 2D reformation image data 116 and the number of pixels associated with particular voxels may vary from voxel to voxel.

The transformation used to unfold the volume may be maintained such that the transformation can later be applied to the registration that maps the 2D contrast image data 132 to the 3D medical image data 112.

Referring once again to operations at the cross-dimensional mapping processing pipeline 130, the image processing logic 200 may generate a registration 134 that maps the pixels of the 2D contrast image data 132 to the 3D medical image data 112 (236).

The registration 134 may be based on various techniques for mapping 2D information to a 3D volume. For example, visible (anatomical) features of the patient in the 2D contrast image data 132 may be matched to the same visible features within the 3D medical image data 112 since the 2D contrast image data 132 and 3D medical image data 112 cover overlapping regions of the patient's anatomy. The matched features may be used to align the 2D contrast image data 132 and 3D medical image data 112. After alignment, the 2D contrast image data 132 may be projected onto the 3D medical image data 112 to obtain the registration of points. Various other 2D to 3D mapping techniques may be used.

Because the registration 134 of points from the 2D contrast image data 132 to the 3D medical image data 112 maps to the individual voxels in the 3D medical image data 112, the registration may be transformed for use with the curved planar data of the 2D reformation image data 116 by applying the same unfolding transformation (previously used to transform the 3D medical image data 112 into the 2D reformation image data 116) to the registration. Thus, the contrast information associated with individual voxels in the 3D medical image data 112 is transferred to the analogous pixel(s) in the 2D reformation image data 116. Thus, the contrast information is super-imposed on the 2D reformation image data 116 (240).

Super-imposition of the contrast information form the 2D contrast image data 132 to the pixels of the 2D reformation image data 116 generates the contrast reformation data 140.

The image processing logic 200 may store the contrast reformation data 140 in memory 150 (250) and/or send the contrast reformation data 140 to a display 160 for presentation to a medical viewer (260).

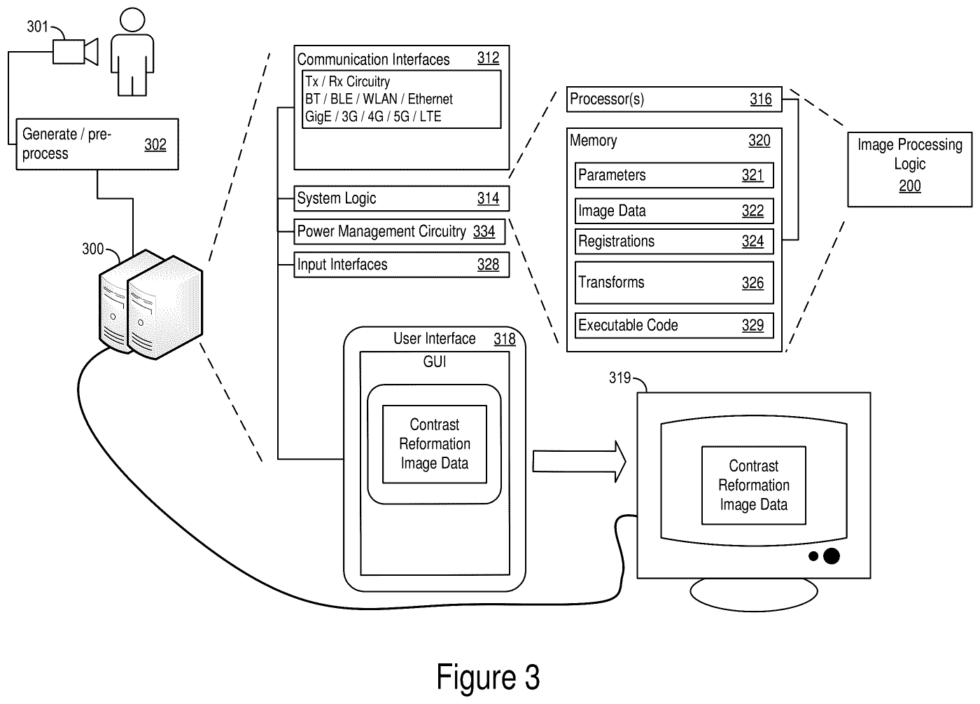

FIG. 3 shows an example image processing environment (IPE) 300, which, for example, may operate as image processing circuitry. The IPE 300 may include system logic 314 to support implementation of the example image processing logic 200. The system logic 314 may include processors 316, memory 320, and/or other circuitry, which may be used to implement the processing pipelines, provide inputs to the pipelines, pass information between the pipelines, execute extractions, execute unfolding operations, execute transformations, generate mappings, and/or perform other processing operations.

In some implementations, the IPE 300 may receive 2D contrast image data and/or 3D medical image data obtained from one or more imaging devices 301. In some cases, an image generation system 302 may generate and/or pre-process contrast images and/or 3D images for processing by the IPE 300. In some implementations, processing to generate and/or pre-process contrast images and/or 3D images may occur on processing system logically or physically separate from the IPE 300.

The memory 320 may be used to store: image data 322, registrations 324, and/or transforms 326 used in processing of medical images and to super-impose contrast information. The memory 320 may further store parameters 321, such as unfold scheme templates, volume skeletonization templates, 2D-3D projection parameters and/or other parameters. The memory may further store executable code 329, which may support input data handling, mapping generation, and/or other image processing functions.

The IPE 300 may also include one or more communication interfaces 312, which may support wireless, e.g. Bluetooth, Bluetooth Low Energy, Wi-Fi, WLAN, cellular (3G, 4G, 5G, LTE/A), and/or wired, ethernet, Gigabit ethernet, optical networking protocols. The IPE 300 may include power management circuitry 334 and one or more input interfaces 328.

The IPE 300 may also include a user interface 318 that may include man-machine interfaces and/or graphical user interfaces (GUI). The GUI may be used to present options for image processing, such as lumen segment selection, parameter definitions, transformation scheme selection, and/or other operator interactions. The user interface 318, e.g., via the GUI, may generate a presentation of the contrast reformation data (or other image data) for display on a display device 319 such as a monitor or other display device. The display may include displaying the unfolded view around the lumen along with contrast information. In some cases, the contrast information may be displayed as a colorization (e.g., due to dye color, post-processing based colorization, and/or other colorization) corresponding the contrast enhancement in the contrast information.

The IPE 300 may be implemented as a localized system, in some implementations. In some implementations, the IPE 300 may be implemented as a distributed system. For example, the IPE 300 may be deployed in a cloud computing environment (such as serverless and/or server-centric computing environments). In some cases, the IPE 300 may be implemented (at least in part) on hardware integrated (and/or co-located) with a user terminal.

### Example Implementations

Various example implementations are described below. The example implementations are illustrative of the various general architectures described above. The various specific features of the illustrative example implementations may be readily used in other implementations with or without the various other specific features of the implementation in which they are described.

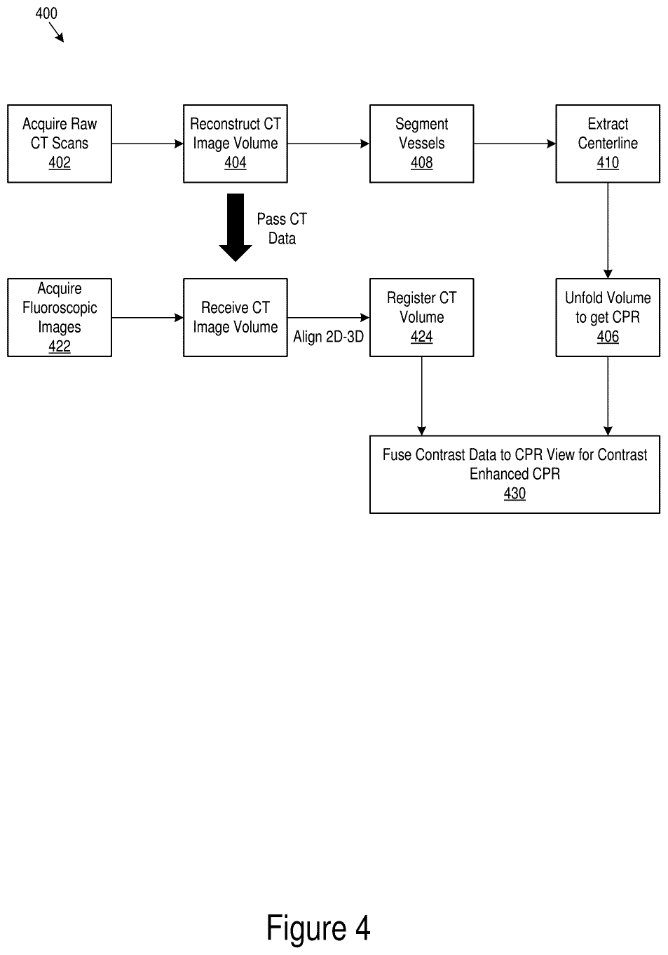

In an illustrative example image processing system 400 shown in FIG. 4, blood-vessel fluoroscopic image data (2D contrast image data) is used in conjunction with pre-operation (pre-op) CT scan images (3D medical image data) to generate curved planar reformation images that are contrast enhanced (contrast reformation data). In the illustrative example image processing system 400, the raw CT scan images are acquired (402) and then reconstructed (404) provide a pre-op 3D CT volume. From the pre-op 3D CT volume, the tree formed by the vessels in the volume is segmented (406), and centerline(s) of the vessel segments are calculated (408). In some cases, the entire tree may be processed in a single pass. 2D reformation data is obtained by unfolding the 3D CT volume around the extracted centerlines (410). In other words, a CPR view is defined based on the centerline of a vessel segment.

Fluoroscopic images are streamed to the image processing system 400 (422). In some cases, the fluoroscopic image may be streamed during performance of an operation, e.g., such that the dynamic condition of vessels can be monitored and/or to accommodate administration of contrast dye or other treatments to support acquisition of the images. The 3D CT volume is passed to be matched to the fluoroscopic image stream. For each 2D fluoroscopy image, 2D-3D alignment and projection are performed, and the registration with the 3D CT volume is computed (424).

The registration is provided for super-imposition of the contrast information from the fluoroscopic image onto the 2D reformation data to provide contrast enhancement of the rendered CPR view.

To render a fused CPR of 3D CT volume super-imposed with contrast information from the fluoroscopy images, a CPR image of a vessel segment is rendered using the 3D CT volume. For every pixel on the CPR view of CT volume, the segmentation result (406) is also sampled with the position of the pixel in the CT volume to check whether the pixel is inside the vessel lumen or not. If the pixel is inside the vessel lumen, the pixel position in the fluoroscopy image is calculated from the registration information. Then the pixel value in the fluoroscopy image can be sampled and super-imposed on the underlying CT volume value (430).

The methods, devices, processing, and logic described in the various sections above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

Table 1 includes various examples.

TABLE 1
Examples

| | |
|---|---|
| 1. | A method including: |

at image processing circuitry:
obtaining three-dimensional medical image data for a lumen within a

patient from a first medical imaging device;

obtaining two-dimensional contrast image data for the lumen from a

second medical imaging device;

at an image reformation processing pipeline: generating two-dimensional

reformation data for the three-dimensional medical image data by
straightening a centerline of the lumen and unfolding the three-
dimensional medical image data about the straightened centerline; and

at a cross-dimensional mapping processing pipeline:

```
      generating a registration of points in the two-dimensional contrast
        image data to points in the three-dimensional medical image
        data; and
      super-imposing the two-dimensional contrast image data on to
        the two-dimensional reformation data using the registration by
        translating the registration from the points in the three-
        dimensional medical image data to the same points in the two-
        dimensional reformation data to generate contrast reformation
        data; and
```

displaying the contrast reformation data on a display.

| | |
|---|---|
| 2. | The method of any other example in this table, where the first medical |

```
  imaging device includes a magnetic resonance imaging (MRI) device, a
  computed tomography (CT) device, or both.
```

| | |
|---|---|
| 3. | The method of any other example in this table, where the second |

```
  medical imaging device includes a fluoroscopic imaging device configured to
  capture images of the patient when exposed to a contrast dye.
```

| | |
|---|---|
| 4. | The method of any other example in this table, where the lumen |

```
  includes a vessel, a portion of the digestive tract, a lymphatic, and/or a
  ganglion.
```

| | |
|---|---|
| 5. | The method of any other example in this table, where displaying the |

```
  contrast reformation data on a display includes displaying a colorization of
  the contrast reformation data to display a contrast enhancement present in
  the contrast reformation data.
```

| | |
|---|---|
| 6. | The method of any other example in this table, where translating the |

```
  registration from the points in the three-dimensional medical image data to
  the same points in the two-dimensional reformation data includes applying
  the unfolding the registration to translation the registration in three-
  dimensional space to a plane of the two-dimensional reformation data.
```

| | |
|---|---|
| 7. | The method of any other example in this table, where unfolding portions |

```
  of the three-dimensional medical image data about the straightened
  centerline includes transforming a volume of the three-dimensional medical
  image data from a sampled three-dimensional rectilinear space to a curved
  planar space.
```

| | |
|---|---|
| 8. | The method of any other example in this table, where generating the |

```
  registration of points includes identifying a visible feature in the three-
  dimensional medical image data and identifying the visible feature two-
  dimensional contrast image data.
```

| | |
|---|---|
| 9. | The method of example 1, where the lumen includes a segmented |

```
  portion of a lumen network imaged at least in part within the three-
  dimensional medical image data.
```

| | |
|---|---|
| 10. | The method of example 9 or any other example in this table, where the |

```
  segmented portion is selected from the lumen network based on an
  anomalous feature present on the segmented portion.
```

| | |
|---|---|
| 11. | The method of example 9 or any other example in this table, where the |

```
  segmented portion is selected from the lumen network based on an
  availability of the two-dimensional contrast image data for the segmented
  portion.
```

| | |
|---|---|
| 12. | The method of any other example in this table, where straightening the |

```
  centerline of the lumen includes performing a volume skeletonization of the
  three-dimensional medical image data to extract the centerline from the
  three-dimensional medical image data.
```

| | |
|---|---|
| 13. | Non-transitory machine-readable media configured to store instructions |

```
  thereon, the instructions configured to, when executed, cause a processor to:
for three-dimensional medical image data and two-dimensional contrast image
  data for a lumen within a patient;
execute a reformation of three-dimensional medical image data to generate
  two-dimensional reformation data by unfolding at least a portion of the three-
  dimensional medical image data around a straightened centerline of the
  lumen;
generate a mapping of points in the two-dimensional contrast image data to
  points in the three-dimensional medical image data;
super-impose, using a translation generated by applying the reformation to the
  mapping, the two-dimensional contrast image data on the two-dimensional
  reformation data to generate contrast reformation data; and
cause a display to display the contrast reformation data.
```

| | |
|---|---|
| 14. | The non-transitory machine-readable media of any example in this |

```
  table, where the instructions are configured to cause the processor to display
  the contrast reformation data on a display by displaying a colorization of the
  contrast reformation data to display a contrast enhancement present in the
  contrast reformation data.
```

| | |
|---|---|
| 15. | The non-transitory machine-readable media of any example in this |

```
  table, where the instructions are configured to cause the processor to
  translate the registration from the points in the three-dimensional medical
  image data to the same points in the two-dimensional reformation data by
  applying the unfolding the registration to translation the registration in three-
  dimensional space to a plane of the two-dimensional reformation data.
```

| | |
|---|---|
| 16. | The non-transitory machine-readable media of any example in this |

```
  table, where the instructions are configured to cause the processor to unfold
  portions of the three-dimensional medical image data about the straightened
  centerline by transforming a volume of the three-dimensional medical image
  data from a sampled three-dimensional rectilinear space to a curved planar
  space.
```

| | |
|---|---|
| 17. | The non-transitory machine-readable media of any example in this |

```
  table, where the instructions are configured to cause the processor to
  generate the registration of points by identifying a visible feature in the three-
  dimensional medical image data and identifying the visible feature two-
  dimensional contrast image data.
```

| | |
|---|---|
| 18. | The non-transitory machine-readable media of any example in this |

```
  table, where the lumen includes a segmented portion of a lumen network
  imaged at least in part within the three-dimensional medical image data.
```

| | |
|---|---|
| 19. | A system including: |

image processing circuitry configured to:
obtain three-dimensional medical image data for a lumen within a patient

from a first medical imaging device;

obtain two-dimensional contrast image data for the lumen from a second

medical imaging device;

at an image reformation processing pipeline:

```
    extract a centerline along the lumen from within a three-
      dimensional space imaged within the three-dimensional medical
      image data;
    straighten the centerline into a single plane to generate a
      straightened centerline; and
    unfold, around the straightened centerline and onto the plane, one
      or more image data portions along the lumen to generate two-
      dimensional reformation data for the three-dimensional medical
      image data; and
```

at a cross-dimensional mapping processing pipeline:

```
    register one or more locations within the three-dimensional medical
      image data to the two-dimensional contrast image data to
      generate a mapping of points in the two-dimensional contrast
      image data to points in the three-dimensional medical image
      data;
    generate a translation of the mapping for the two-dimensional
      reformation data; and
    super-impose, using the translation of the mapping, the two-
      dimensional contrast image data on the two-dimensional
      reformation data to generate contrast reformation data; and
```

a display configured to display the contrast reformation data.

| | |
|---|---|
| 20. | The system of any example in this table, where image processing |

```
  circuitry is further configured to straighten the centerline of the lumen by
  performing a volume skeletonization of the three-dimensional medical image
  data to extract the centerline from the three-dimensional medical image data.
```

| | |
|---|---|
| 21. | A system including circuitry configured to implement any feature or any |

combination of features described in this table or disclosure.

| | |
|---|---|
| 22. | A method including implementing any feature or any combination of |

features described in this table or disclosure.

| | |
|---|---|
| 23. | A method including installing the system of any example in this table. |
| 24. | A product including: |

```
machine-readable media; and
instructions stored on the machine-readable media, the instructions configured
  to cause a processor to perform (at least in part) the method of any example
  in this table, where:
```

optionally, the machine-readable media is non-transitory;
optionally, the machine-readable media is other than a transitory signal;
and
optionally, the instructions are executable.

Headings and/or subheadings used herein are intended only to aid the reader with understanding described implementations. The invention is defined by the claims.

What is claimed is:

1. A method including:
at image processing circuitry:
obtaining three-dimensional medical image data for a lumen within a patient from a first medical imaging device;
obtaining two-dimensional contrast image data for the lumen from a second medical imaging device;
at an image reformation processing pipeline: generating two-dimensional reformation data for the three-dimensional medical image data by straightening a centerline of the lumen and unfolding the three-dimensional medical image data about the straightened centerline; and
at a cross-dimensional mapping processing pipeline:
generating a registration of points in the two-dimensional contrast image data to points in the three-dimensional medical image data; and
super-imposing the two-dimensional contrast image data on to the two-dimensional reformation data using the registration by translating the registration from the points in the three-dimensional medical image data to the same points in the two-dimensional reformation data to generate contrast reformation data; and
displaying the contrast reformation data on a display.

2. The method of claim 1, where the first medical imaging device includes a magnetic resonance imaging (MRI) device, a computed tomography (CT) device, or both.

3. The method of claim 1, where the second medical imaging device includes a fluoroscopic imaging device configured to capture images of the patient when exposed to a contrast dye.

4. The method of claim 1, where the lumen includes a vessel, a portion of a digestive tract, a lymphatic, and/or a ganglion.

5. The method of claim 1, where displaying the contrast reformation data on the display includes displaying a colorization of the contrast reformation data to display a contrast enhancement present in the contrast reformation data.

6. The method of claim 1, where translating the registration from the points in the three-dimensional medical image data to the same points in the two-dimensional reformation data includes applying the unfolding the registration to translate the registration in three-dimensional space to a plane of the two-dimensional reformation data.

7. The method of claim 1, where unfolding portions of the three-dimensional medical image data about the straightened centerline includes transforming a volume of the three-dimensional medical image data from a sampled three-dimensional rectilinear space to a curved planar space.

8. The method of claim 1, where generating the registration of points includes identifying a visible feature in the three-dimensional medical image data and identifying the same visible feature in the two-dimensional contrast image data.

9. The method of claim 1, where the lumen includes a segmented portion of a lumen network imaged at least in part within the three-dimensional medical image data.

10. The method of claim 9, where the segmented portion is selected from the lumen network based on an anomalous feature present on the segmented portion.

11. The method of claim 9, where the segmented portion is selected from the lumen network based on an availability of the two-dimensional contrast image data for the segmented portion.

12. The method of claim 1, where straightening the centerline of the lumen includes performing a volume skeletonization of the three-dimensional medical image data to extract the centerline from the three-dimensional medical image data.

13. Non-transitory machine-readable media configured to store instructions thereon, the instructions configured to, when executed, cause a processor to:
for three-dimensional medical image data and two-dimensional contrast image data for a lumen within a patient;
execute a reformation of three-dimensional medical image data to generate two-dimensional reformation data by unfolding at least a portion of the three-dimensional medical image data around a straightened centerline of the lumen;
generate a mapping of points in the two-dimensional contrast image data to points in the three-dimensional medical image data;
super-impose, using a translation generated by applying the reformation to the mapping, the two-dimensional contrast image data on the two-dimensional reformation data to generate contrast reformation data; and
cause a display to display the contrast reformation data.

14. The non-transitory machine-readable media of claim 13, where the instructions are configured to cause the processor to display the contrast reformation data on the display by displaying a colorization of the contrast reformation data to display a contrast enhancement present in the contrast reformation data.

15. The non-transitory machine-readable media of claim 13, where the instructions are configured to cause the processor to translate the mapping to the points in the three-dimensional medical image data to the same points in the two-dimensional reformation data by applying the unfolding the mapping to translate the mapping in three-dimensional space to a plane of the two-dimensional reformation data.

16. The non-transitory machine-readable media of claim 13, where the instructions are configured to cause the processor to unfold portions of the three-dimensional medical image data about the straightened centerline by transforming a volume of the three-dimensional medical image data from a sampled three-dimensional rectilinear space to a curved planar space.

17. The non-transitory machine-readable media of claim 13, where the instructions are configured to cause the processor to generate the mapping of points by identifying a visible feature in the three-dimensional medical image data and identifying the same visible feature in the two-dimensional contrast image data.

18. The non-transitory machine-readable media of claim 13, where the lumen includes a segmented portion of a lumen network imaged at least in part within the three-dimensional medical image data.

19. A system including:
image processing circuitry configured to:
obtain three-dimensional medical image data for a lumen within a patient from a first medical imaging device;
obtain two-dimensional contrast image data for the lumen from a second medical imaging device;
at an image reformation processing pipeline:
extract a centerline along the lumen from within a three-dimensional space imaged within the three-dimensional medical image data;
straighten the centerline into a single plane to generate a straightened centerline; and
unfold, around the straightened centerline and onto the single plane, one or more image data portions along the lumen to generate two-dimensional reformation data for the three-dimensional medical image data; and
at a cross-dimensional mapping processing pipeline:
register one or more locations within the three-dimensional medical image data to the two-dimensional contrast image data to generate a mapping of points in the two-dimensional contrast image data to points in the three-dimensional medical image data;
generate a translation of the mapping for the two-dimensional reformation data; and
super-impose, using the translation of the mapping, the two-dimensional contrast image data on the two-dimensional reformation data to generate contrast reformation data; and
a display configured to display the contrast reformation data.

20. The system of claim 19, where the image processing circuitry is further configured to straighten the centerline of the lumen by performing a volume skeletonization of the three-dimensional medical image data to extract the centerline from the three-dimensional medical image data.
